(19) United States
(12) Patent Application Publication
(10) Pub. No.: US 2002/0166740 A1
(43) Pub. Date: Nov. 14, 2002

(54) Dissipation of frictional heat from vehicle components

(76) Inventor: Ming Jason Zhang, Montreal (CA)

Correspondence Address: Ming (Jason) Zhang, 5270 Rosedale Avenue, Montreal, H4V 2H6, CA

(21) Appl. No.: 10/141,379

(22) Filed: May 8, 2002

Related U.S. Application Data
(60) Provisional application No. 60/289,981, filed on May 10, 2001.

(51) Int. Cl. F16D 65/10

(52) U.S. Cl. 188/264 AA; 188/218 XL

(57) ABSTRACT

The present invention provides methods and apparatus for efficiently cooling frictional brake components mounted on vehicle or heavy rotating machinery, including frictional lining, brake discs, vehicle wheels served as frictional brake components etc, by inducing intensive forced convective heat transfers on the surfaces of the said frictional brake components. The cooling methods in the present invention include:

(a) providing forced cooling air flows directly to braking surface of frictional brake component where surface temperature is highest among the surfaces of the frictional brake component and where cooling is badly needed for improving safety, braking performances and service lives of the said components;

(b) providing forced cooling air flows of different intensities over different surfaces of the frictional components for the purpose of reducing thermal displacement or deflection, reducing thermal or combination of thermal and mechanical stresses within the said frictional brake components.

(c) providing forced cooling air flows to surfaces of frictional components that do not have any built in self-ventilation features, for example, wheel that is used directly as an frictional brake component.

The above cooling methods are implemented with the help of following cooling apparatus in the present invention:

(a) Ventilator that is integrated into or mounted on the said vehicles or heavy rotating machinery such as a passive fan, with a plurality of radially extended blades, mounted or built into rotary vehicle components, generates additional forced cooling air flows and directs the said additional forced cooling air flows towards or across the selected high temperature surfaces ,for example the braking surfaces, of said frictional brake components;

(b) Air flow deflection means that is integrated into or mounted on the said vehicles or heavy rotating machinery, changes the path of existing air flows within or around the said vehicle or heavy machinery and directs the said existing air flows, such as the forced ventilation air flow generated by ventilated brake disc, towards or across the selected high temperature surfaces of frictional brake components, such as the braking surfaces of annular brake disc.

The implementation of the invented methods and integration of the invented apparatus into the vehicle or heavy machinery thus enables accelerated heat loss from the frictional brake components, reduction of temperatures and thermal stresses within the frictional braking component, improvement on safety and braking performance, and prolonged service lives of frictional brake components.

### CROSS REFERENCE TO RELATED APPLICATIONS

This application claims the benefit of U.S. Provisional Application No. 60/289,981 filed May 10, 2001, which is hereby incorporated by reference in its entirety.

### TECHNICAL FIELD

The present invention relates generally to cooling methods and apparatus for frictional brake components mounted on a vehicle or heavy machinery. In particular, the present invention relates to new air cooling schemes for cooling efficiently frictional brake components mounted on railway vehicles or other heavy duty transport vehicles for the purposes of improving safety and braking performance of the said vehicles and prolonging services lives of braking components.

### BACKGROUND OF THE INVENTION

During vehicle braking, frictional heat is generated on the surfaces of rotary frictional brake components such as brake lining, brake drum, brake disc and those vehicle wheels that are served also as frictional brake components. A large portion of the heat is absorbed quickly by the vehicle components such as wheel, brake drum, brake disc, brake lining etc. and then gradually dissipated to the atmosphere.

Take a railway vehicle as an example, the frictional engagement between wheel tread and brake shoe in a wheel tread braking application, or between brake disc and brake pad in a disc braking application provides retarding force to decelerate and to stop eventually the said railway vehicle, transforming vehicle's dynamic energy into frictional heat that is absorbed by the wheel or the brake discs, then gradually dissipated to the environment.

1. High Temperature Developed on Braking Surfaces of Frictional Brake Components

In both wheel tread braking and disk braking, successive or prolonged braking may result in heat accumulations and continuous temperature rises within frictional brake components such as wheels, brake discs, and brake linings. The excessive temperatures developed in those components, especially on the braking surfaces where frictional components are engaged into each other by braking means, soften the friction material causing reduction of friction material's mechanical strength, premature wear away and decay of the brake shoe or brake pad, abnormal and/or poor braking performance, excessive wear of wheel, brake disc or brake linings.

In general, if heat dissipation from wheel or brake disc can be accelerated, especially from the high temperature braking surfaces, the same wheel or the same brake disc is then capable of operating under higher braking efforts or more intensive frictional heat input without exceeding their material or operational temperature limits.

2. Thermal Stresses Developed Within Frictional Brake Components

In braking, certain amount of thermal stresses arising from thermal expansion or displacement develops within the frictional brake component. Under certain service conditions, thermal stresses developed within frictional brake components can be several times higher than mechanical stresses. Previous studies on railway wheel tread braking found that under severe braking conditions, excessively high thermal loads can effectively destroy the compressive residual hoop stress developed during the wheel manufacturing process. The above mentioned compressive hoop stress in the wheel rim is believed to be beneficial to inhibit the formation of fatigue cracks and/or to retard the progress of fatigue failure.

Obviously, thermal stresses arising from thermal expansion can be significantly reduced if accelerated heat dissipation from the frictional brake component can be achieved resulting in less significant temperature rises within those components.

Since the retained frictional heat may not only damage the vehicle components but also impair the vehicle braking performances thus jeopardizing the vehicle safety, numerous efforts have been made to rapidly dissipate the heat from the vehicle's frictional components.

U.S. Pat. No. 5,901,819 to Engle, which is incorporated herein by reference, discloses a braking system in which brake shoes are applied both to wheel treads and to discs attached to the wheel/axle assemblies, to maximize the heat that can be absorbed and communicated to the environment.

U.S. Pat. No. 5,826,685 to Engle, which is incorporated herein by reference, discloses a brake disc having two annular portions spaced apart axially from one another which have at least one opening there between, and which have axisymmetric friction surfaces sloped in opposition to each other for contact with a brake shoe.

U.S. Pat. No. 5,551,761 to White, which is incorporated herein by reference, discloses a automobile type of vehicle wheel having a multiplicity of pin fins built up on wheel surfaces and being in thermal contact with rear surface of brake drum.

U.S. Pat. No. 5,507,370 to White, et al., which is incorporated herein by reference, discloses an annular heat sink placed between an automobile brake drum and a wheel assembly and in thermal contact with rear surface of brake drum.

U.S. Pat. No. 4,928,798 to Watson et al, which is incorporated herein by reference, discloses a brake disc having vanes with reduced overall diameters, but the same cooling effect due to the combination of shorter vanes and pillars.

U.S. Pat. No. 4,508,200 to Cigognini, which is incorporated herein by reference, discloses a disc brake system that is essentially a reverse arrangement compared to the conventional brake systems. The proposed system comprises a rotating part mounted on a shaft to be braked that is less thermal conductive, whereas the stationary part being a material of more thermal conductive and being provided with internal cavities for a fluid for dissipating the braking heat, which passes almost totally to the stationary part.

U.S. Pat. No. 4,013,146 to Gebhardt et al, which is incorporated herein by reference, discloses a brake disc that has a radial impeller mounted in the space inwardly of the friction ring and the said impeller has an axial intake and a radial outlet directed toward the cooling air ducts of the brake disc.

Since new vehicles including automobile or rail guided type, are constantly designed to travel at higher speeds or under heavier loads, and to stop more frequently or at relatively short intervals of time, the frictional brake components are required on the one hand, to be more heat resistant in terms of for example, developing less or tolerate higher internal thermal stresses or having more stable braking performance at higher operating temperatures, on the other hand, to dissipate themselves more frictional heat at greater rate.

Following are some inefficiency in terms of heat dissipation and heat resistance observed in the present designs of frictional braking means:

For ventilated brake discs,

Although forced air flows are induced between two friction rings of a brake disc by radially extended fins, the said air flow does not make a significant impact to the cooling of the brake disc since the said air flows passes across only rear surfaces of the friction rings and only a small fraction of frictional heat can be transferred to the said rear surfaces in a reasonable length of time. Meanwhile, no strong cooling airflow is generated from or directed to braking surfaces of brake pads and braking surfaces of brake disc where immediately reached local high temperatures may cause severe thermal or mechanical damages to the frictional brake components.

For solid brake discs and those wheels served as frictional brake components in wheel tread braking,

No strong forced ventilation is provided to them, consequently, the absorbed frictional heat can only be dissipated slowly from those components.

For dual functional components such as those railway freight car wheels that are served also as a frictional brake component,

Thermal stress developed within those wheels can often be several times higher than the stresses arising from vehicle's mechanical loads, making the said thermal stress still one of the primary causes for wheel failure.

Accordingly, what are needed in the art are methods and apparatus that are able to

(1) Provide additional or enhanced air cooling to frictional brake components;

(2) Accelerate heat losses directly from high temperature surfaces, especially braking surfaces of frictional brake component;

(3) Lower internal thermal stresses within the frictional brake component.

### SUMMARY OF THE INVENTION

The principal object of the present invention is to implement new air cooling methods and integrate new air cooling apparatus that enable enhanced heat dissipation from the selected high temperature surfaces of the frictional brake components, reduction in internal thermal stresses within the braking components, improvement in vehicle braking performance and in vehicle operational safety.

Another object of the present invention is to provide the above mentioned new cooling methods and apparatus without interfering with the present vehicle's running and maintenance operation, or increasing substantially vehicle mass thus the consumption of vehicle's motive power.

Those objects of the present invention can be accomplished by

(1) Integrating into the vehicle or other heavy machinery, lightweight ventilators that are able to provide additional cooling air flows to the critical surfaces of frictional brake components;

(2) Integrating into the vehicle or other heavy machinery, lightweight airflow deflectors that are able to direct existing air flows within or around the vehicle to the selected critical surfaces of frictional brake components;

(3) Inducing selectively forced convective heat transfer of different intensities over different surfaces of frictional brake components in order to achieve overall reduction of thermal displacement and thermal or combination of thermal and mechanical stresses developed within the said components.

Other objects and advantages of the present invention can become more apparent to those skilled in the art as the nature of the invention is better understood from the accompanying drawings and a detailed description.

### BRIEF DESCRIPTION OF THE DRAWINGS

FIG. 1 is an end view of one embodiment of the present invention in which a pair of wheel ventilators is attached from both sides to a vehicle wheel.

FIG. 1A is a partial cross sectional view of the apparatus depicted in FIG. 1 taken along the line 1A-1A, showing the pair of ventilators and their assembly to the wheel.

FIG. 1B is a complete cross sectional view of the apparatus depicted in FIG. 1A taken along the line 1B-1B, showing the construction of the said ventilators.

FIG. 1C is an end view of an alternative embodiment of the present invention to the one shown in FIG. 1, in which another type of wheel ventilator is mounted only from one side to the said wheel by force fitting to the hub of the said wheel.

FIG. 1D is a partial cross sectional view of the apparatus depicted in FIG. 1C taken along the line 1D-1D, showing the ventilator and its assembly to the wheel.

FIG. 2 is a cross sectional view of another embodiment of the present invention in which a pair of low profile disc ventilators is attached to an axle from both sides of a solid brake disc.

FIG. 2A is a cross sectional view of the apparatus depicted in FIG. 2 taken along the line 2A-2A, providing a complete end view of the disc ventilator and its assembly with the axle.

FIG. 2B is a cross sectional view of the apparatus depicted in FIG. 2 taken along the line 2B-2B, showing the inner structure of the said disc ventilator.

FIG. 3 provides an end view of another embodiment of the present invention in which a non-rotary airflow deflector is mounted to a vehicle equipped with ventilated brake disc.

FIG. 3A provides a partial cross sectional view of the non-rotary airflow deflector shown in FIG. 3 taken along the line 3A-3A, showing the structure of the airflow baffle shroud of the said airflow deflector.

### DETAILED DESCRIPTION OF THE DRAWINGS

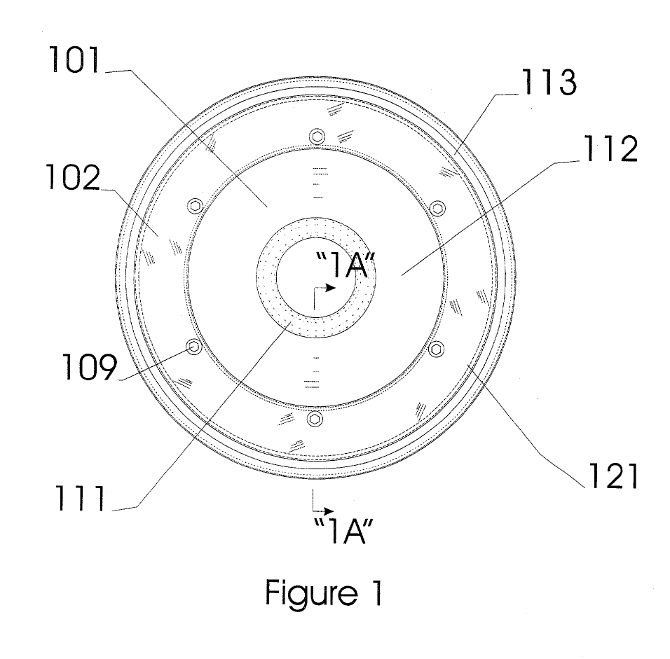

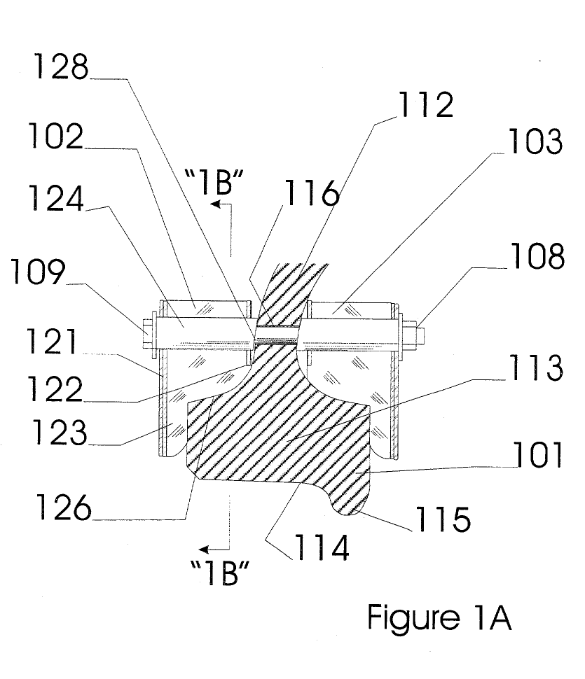

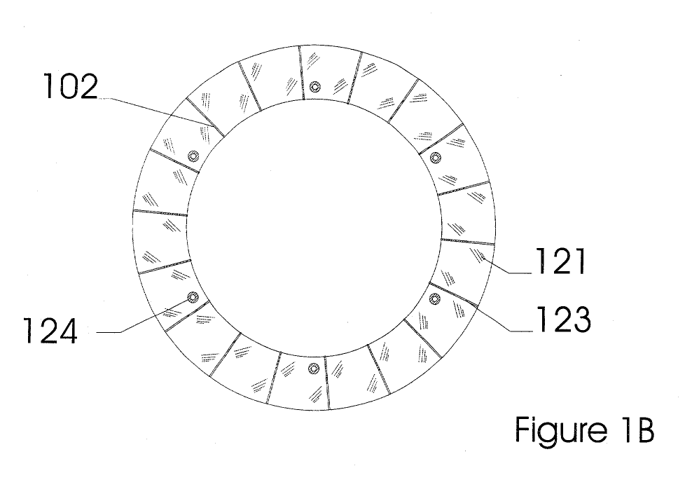

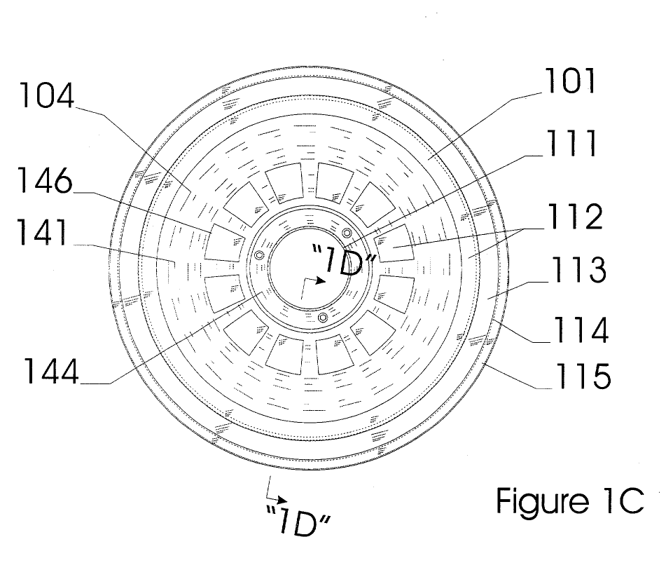

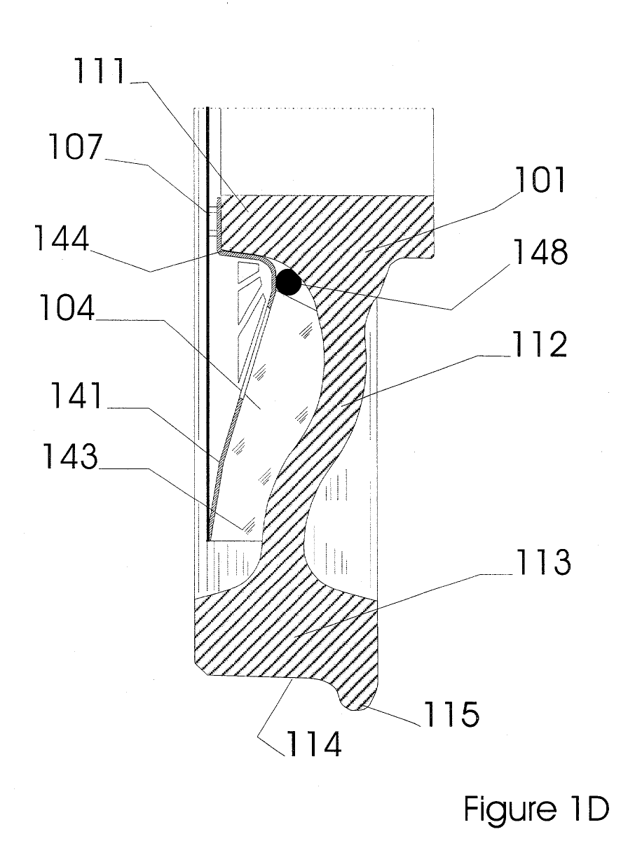

Referring to FIG. 1, FIG. 1A and FIG. 1B, a pair of wheel ventilator 102 and 103 are provided to a wheel member 101 of a railway vehicle. The different sections of the said wheel 101 are indicated as following: wheel hub 111, wheel web 112, wheel rim 113, wheel tread 114 and wheel flange 115. The wheel 101 provides a plurality of geometrically positioned apertures 116 in the wheel web 112. The ventilator 102 and 103 are connected from both sides to the wheel 101, using a plurality of conventional bolts 109 and nuts 108 means, in such a way that they can follow possible thermal expansion of the wheel 101. In terms of principles of construction and assembly, the ventilator 102 and 103 are substantially identical to each other, therefore only the ventilator 102 will be described in greater details hereinafter.

Referring to FIG. 1, FIG. 1A and FIG. 1B, the ventilator 102 comprises two annular spaced apart members arranged coaxially with respect to each other: a front plate 121 and a back plate 122. The said front plate 121 and the back plate 122 are connected by a set of geometrically spaced/radially extended fins 123 and a set of geometrically spaced spacers 124, each being joined or attached by a conventional method to the plate 121 and 122 and forming an integral ventilator 102 as a single piece. Each of the said spacers 124 has an extension that provides an end face 128 substantially conformable to the profile of the contact area on the wheel web 112. The said spacers 124 actually serve dual functions as reinforcement for the ventilator 102 and as guide for alignment of the apertures for receiving bolts 109.

The shape and sizes of the fins 123, the front plate 121 and the back plate 122 are configured according to the present invention to generate and to direct favorable cooling air flows to the wheel 101.

It should be noted that the ventilator 102 and 103 may be of any type of lightweight structures such as formed sheet metal/metal plate structure, shell structure etc. and may be integrally formed with or attached by any suitable means e.g. casting, welding, riveting, or bolting together.

While the front plate 121 and the back plate 122, and the fins 123 depicted in the FIG. 1A are substantially straight plates with smooth surface finish, and the intervals between the front plate 121 and the back plate 122 are substantially uniform, it is to be understood that they may also be configured in different shapes and/or in different surface finishes, having variable intervals in the radial direction, according to the present invention, to produce a favorable strong cooling airflow and meanwhile to have relative simple and inexpensive structures with required strengths. For example, the intervals between the front and back plate may be gradually reduced in the outward radial direction thus further increasing the outlet cooling airflow speed and providing more intensive cooling to the rear of wheel rim 113 than to the wheel web 112.

Some conventional sealing or cushioning means may be applied to seal the clearance 126 between the fins 123 and the wheel 101. For example, a layer of resilient material with relatively high thermal conductivity may be placed in the interval 126 to improve the air pumping efficiency, reduce the vibration/noise and encourage the heat transfers between the ventilator 102 or 103 and the wheel 101. Other conventional shock absorption means may be implemented to further reduce the noise and vibration that may occur on ventilator 102 and 103, for example, incorporating vibration-damping member in form of washers, collars or springs made in resilient material to the wheel and ventilator assembly.

Instead of having a one-piece structure, the ventilator 102 and 103 may be constructed alternatively in form of an assembly of multiple split segments to facilitate their assembly and disassembly processes.

The front plates and back plates, the fins and the spacers of the ventilator 102 and 103 are made of any suitable heat resistant and lightweight material including but not limited to, copper, copper alloy, aluminum, aluminum alloys, carbon steel or stainless steels, suitable type of plastic material or composite.

In operation, the ventilator 102 and 103 rotate with the rotating wheel 101, each producing a forced airflow by its radially extended fins (for example, 123 in ventilator 102) and directing the said airflow towards the wheel rim 113 and across the wheel web 112. The said cooling air flows help to dissipate the heat transferred from the braking surfaces, which is the wheel tread surface being in frictional engagement with the brake shoes, resulting in improved stability of braking operation and extended service lives of frictional brake components such as wheels and brake shoes. The accelerated heat dissipation from the said wheel rim also help to reduce the internal temperature rises within the wheel, thus reducing the amplitude of the thermal expansion and internal thermal stress within the said wheel 101 that is extremely important to the safety of the wheels.

While the present invention is depicted with a pair of ventilator 102 and 103 mounted to the web section of a specific curved shaped wheel 101, it is to be understood that the present invention is also applicable for uses with other types of wheels which may have different contour, shape and other attachments to it; and with other alternative mounting/arrangement means. One example of alternative mounting/arrangement for the said ventilator is shown in FIG. 1C and FIG. 1D, in which an alternative single ventilator 104, having a hub formed by inwardly extending the front plate of the said ventilator, is mounted to the wheel hub 111 from the front side, instead of mounting to the wheel web from both sides as shown in FIG. 1.

Referring to FIG. 1C and FIG. 1D, a ventilator 104 is mounted to the front face of the wheel 101. The said ventilator comprises a front plate 141 and a plurality of geometrically spaced fins 143 that each of them is joined, attached to or formed directly from the said front plate 141 by a conventional method. Compared with ventilator 102 shown in FIG. 1, the ventilator 104 differentiates in the following aspects:

1. The front plate 141 of the ventilator 104 is extended inwardly forming a hub section 144 in the center of the ventilator;

2. The front plate 141 has a plurality of geometrically spaced opening 146 that serve as air intakes for the said ventilator 104;

3. Back plate and spacers are eliminated while the fins 143 of the ventilator 104 are pressed against the wheel web directly upon assembly of the ventilator 104 to the wheel 101. The fins 143 of the ventilator 104 are substantially conformal to the profiles of the corresponding section of the wheel web 112;

4. The ventilator 104 is mounted to the wheel hub 111 by force fitting and optionally secured by a plurality of threaded bolting means 107 that are mounted to the face of the wheel hub 111;

5. The ventilator 104 is substantially smaller and is confined within the inner periphery of the wheel rim 113, in compliance with the required rail track clearance;

6. A damping ring 148 made of any suitable resilient material is integrated into the assembly to effect necessary vibration and/or noise damping for the ventilator 104.

The above arrangement of the ventilator is helpful especially for providing a ventilator to the types of wheels that do not allow any creation of apertures in its web or rim sections due to the concerns of possible stress concentration and initiation of fatigue cracks in those areas.

Upon frictional heat input in the tread of the railway wheel 101 during braking, wheel deflection and high tensile stress therefrom may develop on front face of the curve shaped wheel web arising from relatively larger thermal expansion on the front face side of the wheel, i.e. the side without wheel flange, than the back face side of the wheel, i.e. the side with wheel flange 115.

Mounting of a single ventilator 104 only on the front face side of the said wheel 101 provides more intensive air cooling to the front face side of the wheel than to the back face side of the wheel. Such a method of inducing forced air cooling of different intensities results in reduced wheel displacement, reduced thermal stresses in the wheel 101 and improved operation safety for the vehicle.

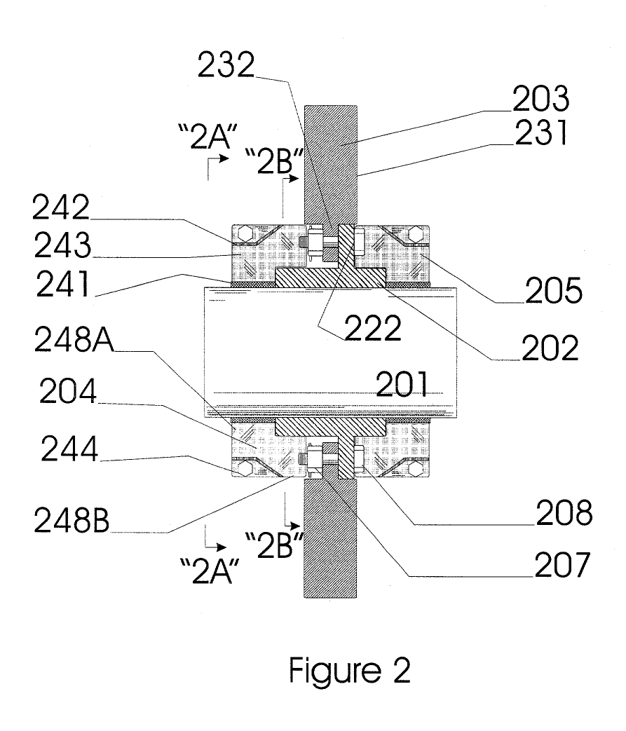

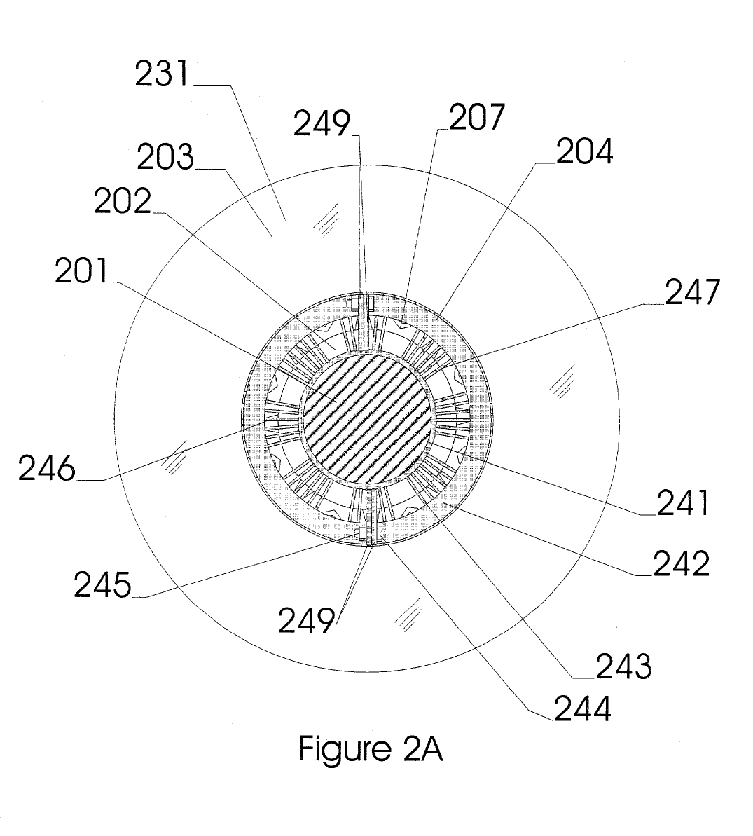

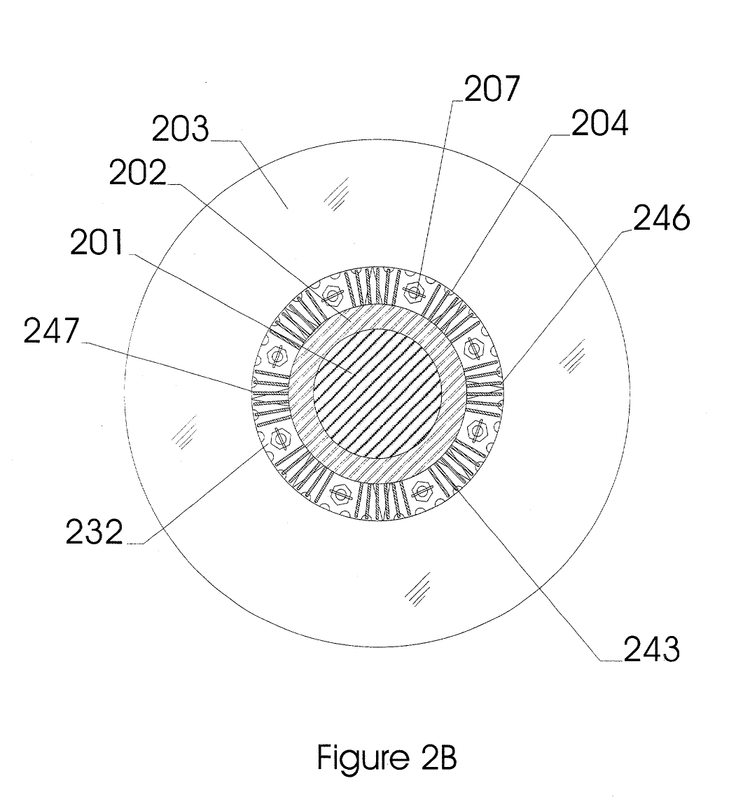

Referring to FIG. 2, FIG. 2A and FIG. 2B, a solid brake disk 203 is mounted on an axle 201 through a hub member 202 that is force fitted to the axle 201. The brake disc 203 comprises an annular friction ring 231 and a plurality of mounting lugs 232 inwardly extended from the inner periphery of the friction ring 231, each said mounting lug having at least one aperture that corresponds to an aperture in the hub 202.

The assembly of the brake disc 203 and the axle 201 is achieved by interconnecting the brake disc 203 to the hub member 202, with the help of a plurality of bolts 208 projecting through the aligned apertures and nuts 207 securing the bolts 208 on the opposite ends.

A pair of low profile disc ventilator 204 and 205 is attached to the axle 201 in a conventional manner. In terms of principles of construction and assembly, the cooling apparatus 204 and 205 are substantially identical to each other; therefore only the ventilator 204 will be described in greater details hereinafter.

As best shown in FIG. 2A and FIG. 2B, the ventilator 204 is composed of two substantially identical semi-annular split-segment 246 and 247 and each split-segment, the segment 247 for example, comprises a semi-annular hub member 241, a semi-cone shroud member 242 and a series of radially extended fins 243 that joined to or built up from both hub 241 and shroud 242 therefore forming an integral segment 247.

The shroud members 242 of the ventilator 204 are shaped in a manner that brings about as much as possible a streamlined airflow from the axially opened air inlets 248A to the radially opened air outlets 248B and then direct the induced airflow to the braking surfaces of the brake disc 203. The said ventilator 204 is substantially smaller than the inner periphery of the solid friction ring 231 of the brake disc 203 so as to avoid any interference with the brake pad upon its frictional engagement with the braking surfaces of the said friction ring 231. The shroud 242 and fins 243 may be shaped/arranged differently according to the present invention to provide favorable strong cooling air flows to the braking surfaces of the friction ring 231 of the brake disc 203.

Two split-segments 246 and 247, each having two end plates 249 joined to the splitting faces at both ends of the said segment and each having at least one aperture in each end plate 249, are interconnected and secured to each other by a conventional method such as by a plurality of bolts 244 and nuts 245 means. The hub 241 of the assembled ventilator 204 has a bore diameter substantially smaller than the axle diameter thus upon mounting to the axle 201, being tightly engaged with the said axle 201.

An intermediate member made in resilient material such as a layer of rubber or a split rubber ring may be placed between the hub 241 and the axle 201 to provide resilient clamping and vibration damping for the said ventilators.

It should be noted that the ventilator 204 and 205 may be constructed alternatively, for example, instead of an assembly of several detachable segments as described above by 246 and 247, the ventilator may be a one-piece ventilator mounted to the axle 201 by force fitting.

It should be noted that ventilator 204 and 205 may be constructed in any possible structures, preferable lightweight one such as formed metal sheet or shell structure and are made of any suitable lightweight and/or heat resistant material, including but not limited to, copper, copper alloy, aluminum, aluminum alloys, carbon steels or stainless steels, suitable plastic or composite material etc.

While the present invention is depicted with a pair of ventilator 204 and 205 mounted to a specific shaped axle 201 together with a solid brake disc, it is to be understood that the present invention is also applicable for uses with other types of wheel set assembly equipped with other types of single or multiple brake discs; and for uses with other alternative mounting means. For example, the brake disc may be a ventilated type mounted on a wheel hub instead of on an axle, and the pair of ventilators may be integrated structurally with the disc hub instead of being separate units.

In operation, the installed ventilator 204 and 205 rotate with the rotating axle 201, each producing forced air flows by its radially extended fins, such as the fins 243 in the ventilator 204, and directing the produced air flows by its shroud, such as the shroud 242 in the ventilator 204, to the braking surfaces of the friction ring 231 of the brake disc 203. The pumped ventilation air flows cool the brake disc 203 and the brake pad that are in frictional engagement between their braking surfaces, and help to dissipate the heat produced by vehicle braking directly from the high temperature braking surfaces, thereby improving stability of the braking operation and extending the service lives of brake disc and brake pad.

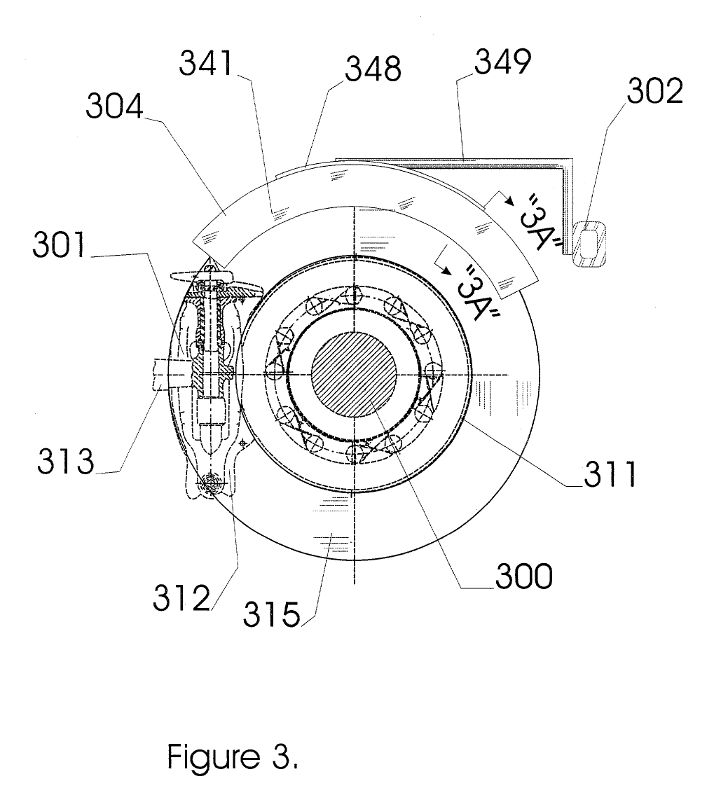

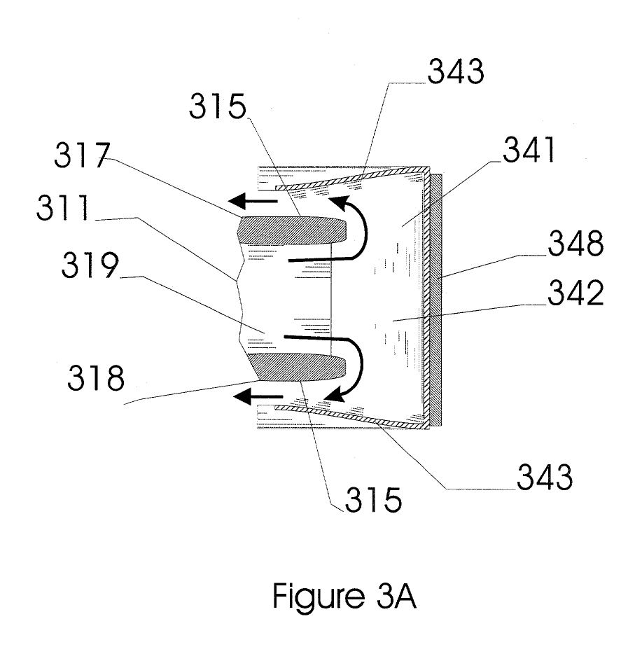

Referring to FIG. 3, FIG. 3A, an airflow deflector 304 is provided to a railway car equipped with a disc braking means 301. The said disc braking means 301 comprises a rotary ventilated brake disc 311 mounted to a rotary member of the said railway car such as an axle 300 or a wheel, a pair of brake shoe and pad assemblies 312 that is in frictional engagement with the brake disc 311 by a disc brake actuating means 313.

The airflow deflector 304 consists of a baffle shroud member 341, a shroud reinforcement member 348 and a support arm member 349. The curve-shaped baffle shroud 341 is positioned coaxially with the brake disc 311, over a section of the outer periphery of the brake disc that is not engaged with the brake pads. The said shroud 341 is mounted to a non-rotary member of the said railway car such as a truck frame 302 of the railway car through the rigid curve-shaped shroud reinforcement member 348 and the support arm 349 that are attached or joined to the said truck frame 302 by a conventional means. Such a mounting arrangement avoids on the one hand, any interference with the brake activating operation or regular car / truck maintenance operation, and to facilitate on the other hand, its own mounting and dismounting processes.

As best shown in FIG. 3A, the ventilated brake disc 311 comprises a pair of spaced apart friction rings 317 and 318 that provides a pair of braking surfaces 315, and a series of radially extended fins 319 that connected to the rear of both friction rings 317 and 318.

The airflow baffle shroud 341, with a substantially U-shaped radial cross section, comprises an arc shaped bottom plate 342 and a pair of sectional ring shaped side plates 343 extended from the bottom plate section 342. The arc shaped bottom plate 342 is coaxially positioned over the outer periphery of the annular brake disc with a substantially uniform gap. Meanwhile the pair of side plates 343 that are sloped inwardly, shroud a substantial portion of the outer periphery of the brake disc 311 with a tapered gap between each side plate 343 and the braking surface 315.

The airflow deflector 304 is made of any suitable lightweight and/or heat resistant material including but not limited to, copper, copper alloy, aluminum, aluminum alloys, carbon steels or stainless steels, any suitable type of plastic or composite material.

While the airflow deflector 304 shown in FIG. 3 surrounds only a portion of the outer periphery of the brake disc 311 and mounted to a non-rotary member of the vehicle, it is to be understood that the present invention is also applicable for uses with other types of airflow deflection means that may surround multiple portions of or the whole outer periphery of the brake disc, provide additional radially extended baffle plates within the baffle shroud or be fully or partially integrated or built into the rotary brake disc or other vehicle components.

In operation, as the brake disc 311 rotates with the rotating axle 300, forced airflow is generated by the radially extended fin 319, passes through the radial slots between the pair of friction rings 317 and 318, cools the rear surfaces of the said friction rings and is then pumped out of the brake disc 311 by the openings at its outer periphery. By virtue of the presence of the airflow deflector 304, the forced air flows discharged from the sections of the outer periphery of the brake disc 311 that are shrouded by the baffle shroud 341, are deflected by the air flow baffle shroud 341, and are forced to escape from the gradually reduced gaps between the shroud 341 and the braking surfaces 315. Upon passing through the said gaps, the deflected cooling air flow is further accelerated, inducing strong forced convective air cooling across the high temperature areas of the braking surface 315. Consequently, brake disc 311 is cooled effectively with accelerated heat loss not only from the rear surfaces of the friction ring 317 and 318 but also from the high temperature braking surfaces 315 of the brake disc 311.

The shapes and sizes of the airflow baffle shroud 341 and intervals between the shroud 341 and the brake disc 311 are configured to produce favorable cooling air flows for the brake disc 311, especially for the braking surfaces 315 and in the mean time to avoid substantial resistances against the forced cooling air flow or substantial air drags to the running vehicle.

### Notes

While the ventilators and airflow deflectors described above may be constructed in forms of assemblies of separate detachable components, they may also be constructed in accordance with the present invention by forming them directly on wheel, brake assembly, wheel set assembly or truck frames.

While the items of the present invention are presented in form of several individual embodiments adapted to a particular vehicle, it is to be understood that the present invention is also applicable for use with all possible combinations of the said individual embodiment and their possible alternatives, and for use with different types of vehicles or heavy machinery.

While a few of the embodiments of the present invention have been explained, it will be readily apparent to those skilled in the art of the various modifications which can be made to the present invention without departing from the spirit and scope of this application as it is encompassed by the following claims.

What I claim as my invention is:

1. A method for cooling frictional brake components mounted on a vehicle or heavy machinery by providing forced cooling air flows to braking surfaces of frictional brake components for the purpose of accelerating heat loss directly from the high temperature braking surfaces of frictional brake components and reducing internal thermal stresses within the said components, with the benefits of improving vehicle braking performances, prolonging service lives of the said components; the said braking surfaces being the frictional contact surfaces of either a rotary or a non-rotary frictional brake component that are engaged into each other during braking application.

2. The method of providing cooling air flows, as recited in claim 1, is further characterized by providing a ventilation means mounted or built into the said vehicle or heavy machinery, the said ventilation means having at least a plurality of geometrically spaced blades that generate air flows to cool the said braking surfaces of the said friction brake components.

3. The said ventilation means in claim 2 is further characterized by having radially-extended blades connected to a rotary member of the said ventilation means that is mounted to the vehicle and by generating cooling air flows to cool the said braking surfaces of the said frictional brake components regardless of rotating direction of the said rotary vehicle components.

4. The frictional brake components in claim 3 are solid brake discs having at least one solid friction ring connected directly or indirectly through intermediate hub member to a wheel/axle assembly of a rail guided vehicle equipped with disc braking means, and frictional linings being in frictional engagement with the said brake discs during braking.

5. The said ventilation means in claim 3 is further characterized by
(a) having a lightweight structure including but not limited to formed sheet metal or metal plate structure, shell structure etc;
(b) and/or being made of lightweight material including but not limited to lightweight metals or their alloys, plastic or composite material.

6. The method of providing cooling air flows, as recited in claim 1, is further characterized by providing an air flow deflection means mounted or built into the said vehicle or heavy machinery, the said air flow deflection means changing the flow path of existing strong air flows within or around the said vehicle or heavy machinery and directing the deflected air flows to the said braking surfaces of the frictional brake components.

7. The method of providing an air flow deflection means, as recited in claim 6, is further characterized in that
(a) the said braking surfaces of frictional brake components are annular braking surfaces of a pair of spaced apart friction rings of a ventilated brake disc;
(b) the said existing air flows are the forced ventilation air flows that pass, upon rotation of the said ventilated brake disc, through the spaces between the pair of spaced apart friction rings of the said brake disc;
(c) the said air flow deflection means is mounted on non-rotary vehicle components and provides at least one air flow baffle shroud with substantially U shaped radial cross section, the said baffle shroud surrounding with a gap at least a portion of outer periphery of the said ventilated brake disc, deflecting the existing cooling air flows generated by the said rotating ventilated brake disc and directing the deflected air flows across the braking surfaces of the said ventilated brake disc.

8. The ventilated brake disc in claim 7 is a railway type of ventilated brake disc mounted on a railway vehicle equipped with disc braking means.

9. The method of providing an air flow deflection means, as recited in claim 6 is further characterized by providing shrinking passages with gradually reduced cross sections for the deflected air flows as a means to provide further intensified cooling airflow with increased flow speed to the said braking surfaces of frictional brake components.

10. A method for cooling a vehicle wheel that is served also as a rotary frictional brake component for braking the vehicle, by providing forced cooling air flows to high temperature surfaces of the said vehicle wheel, the said method being invented for the purpose of reducing temperatures, thermal displacement and internal thermal stresses within the said wheel, with the benefits of improving vehicle safety and braking performances, and prolonging service lives of the said wheel as well as frictional brake lining that is frictional contact with the said wheel during vehicle braking.

11. The method of cooling a vehicle wheel, as recited in claim 10, is further characterized by providing strong forced cooling air flows to high temperature surfaces of the said wheel, and relatively weak if not none forced cooling air flows to low temperature surfaces of the said wheel.

12. The method of cooing a vehicle wheel, as recited in claim 10, is further characterized by providing strong forced cooling air flows to sections of the wheel in high thermal expansion while providing relatively weak if not none forced cooling air flows to other sections of the said wheel in low thermal expansion or in contraction for the purpose of reducing thermal displacement and internal thermal stresses in the said wheel.

13. The method in claim 10, wherein
(a) the vehicle is a type of rail-guided vehicle including but not limited to railway freight car, railway passenger car, self-propelled railway passenger cars or railway locomotive etc.
(b) the vehicle wheel is a railway type of wheel of which the tread surface is served as braking surface for frictional engagement with friction lining by a wheel tread braking means.

14. The method of providing forced cooling air flows, as recited in claim 10, is further characterized by providing shrinking passages with reduced cross sections to accelerate the passing air flows and to effect intensified cooling to the wheel.

15. The method of providing forced cooling air flows, as recited in claim 10 is further characterized by providing a ventilation means comprising
(a) a plurality of blades that are connected to the wheel directly or indirectly through other members of the ventilation means and that generate cooling air flows upon rotation of the said wheel;
(b) at least one shroud member or duct member that helps to direct the generated air flows towards or across the selected high temperature surfaces of the said wheel, and/or helps to form either substantially constant or shrinking passages for accelerating passing air flows.

16. An apparatus for cooling frictional brake components mounted on a vehicle or rotating machinery, the apparatus comprising:
(a) a vehicle wheel set assembly including at least a pair of wheels connected to an axle or a rotary shaft and shaft bearing assembly in a rotating machinery;
(b) a frictional braking means with or without built in self ventilation features, the said frictional braking means including at least one rotary frictional brake component and one non-rotary frictional brake component that are engaged into each other during vehicle braking application or rotating machinery braking application;
(c) at least a pair of braking surfaces being the frictional contact surfaces of a rotary and a non-rotary frictional brake component that are engaged into each other during braking application.
(d) a ventilation means including a plurality of geometrically spaced blades that are connected to a rotary member and generate forced cooling air flows upon rotation of the said rotary member, and at least one air flow guiding shroud that directs the said generated air flows towards or across high temperature braking surfaces of the frictional brake component.

17. The apparatus in claim 16, wherein
(a) the vehicle is a type of rail-guided vehicle including but not limited to railway freight car, railway passenger car, self-propelled railway passenger cars or railway locomotive;
(b) the frictional braking means is a railway type of disc braking means including at least one rotary brake disc and one non-rotary frictional lining that are engaged into each other during the said rail-guided vehicle braking application.

18. The apparatus in claim 16, wherein
(a) the frictional brake means is a disc braking means using solid brake disc as rotary frictional brake component;
(b) the ventilation means is further characterized by
(1) radially extended blades connected to a hub member that is mounted to an axle member of the said vehicle wheel set;
(2) lightweight structural configuration including but not limited to pressed sheet metal/metal plate structure, shell structure and/or usage of lightweight material including but not limited to light weight metals, their alloys, plastic or composite material;
(3) low profile configuration that is able to position itself near the brake disc by occupying the space available within the inner periphery of the brake disc;
(4) mounting to both sides of the solid brake disc.

19. An apparatus for cooling frictional brake components mounted on a vehicle, the apparatus comprising:
(a) a vehicle wheel set assembly including at least a pair of wheels connected to an axle;
(b) a frictional braking means that uses vehicle wheels as rotary frictional components which are engaged with non-rotary frictional brake components during vehicle braking;
(c) multiple or a single ventilation means consisting of a plurality of geometrically spaced blades and air flow guiding shrouds or ducts that are connected to the said wheel directly or indirectly through an intermediate member and that generate forced cooling air flows upon rotation of the said wheel, and to direct the said generated air flows towards or across the surfaces of the said wheel.

20. The apparatus in claim 19, wherein the ventilation means is further characterized by
(a) having a plurality of radially extended blades connected to two spaced apart annular shrouds member forming a plurality of air ducts that generate and direct cooling air flows towards and/or across the wheel web and wheel rim upon rotation of the said wheel;
(b) mounting to the web section of the said wheel;
(c) having lightweight structural configuration including but not limited to pressed sheet metal/metal plate structure, shell structure and/or using lightweight material including but not limited to light weight metals, their alloys, plastic or composite material.

21. The said ventilation means in claim 19 is further characterized by having
(a) having a plurality of radially extended blades connected to an annular shroud member that is spaced apart from the wheel web forming together with the wheel web a plurality of air ducts that generate and direct cooling air flows towards and/or across the wheel web and wheel rim upon rotation of the said wheel;
(b) having a hub member extended from the said shroud;
(c) mounting to the wheel hub through force fitting including press fitting or shrink fitting means.
(d) having lightweight structural configuration including but not limited to pressed sheet metal/metal plate structure, shell structure and/or using lightweight material including but not limited to light weight metals, their alloys, plastic or composite material.

22. The ventilation means in claim 19 is further characterized by its mounting only on the side of the wheel having higher thermal expansion and/or providing shrinking passages to accelerate passing cooling air flows and to effect intensified cooling in either high temperature sections and/or high thermal expansion sections of the wheel, for the purposes of reducing thermal displacement and/or thermal stresses within the said wheel.

23. An apparatus for cooling frictional brake components mounted on a vehicle or rotating machinery, the apparatus comprising:
(a) a vehicle wheel set assembly including at least a pair of wheels connected to an axle or a rotary shaft and shaft bearing assembly in a rotating machinery;
(b) a frictional braking means including at least one rotary frictional brake component and one non-rotary frictional brake component that are engaged into each other during frictional braking application;
(c) at least a pair of braking surfaces being the frictional contact surfaces of a rotary and a non-rotary frictional brake component that are engaged into each other during braking application.
(d) an air flow deflection means including at least one air flow baffle means with or without other air flow guiding shroud or duct that deflects and directs existing air flows within or around the said vehicle or heavy machinery to the high-temperature surfaces of the frictional brake components.

24. The apparatus in claim 23, wherein the vehicle is a type of rail-guided vehicle including but not limited to railway freight car, railway passenger car, self-propelled railway passenger cars or railway locomotive;

25. The apparatus in claim 23, wherein
(a) the said rotary frictional brake component is a ventilated brake disc with a pair of annular spaced apart friction rings;
(b) the said existing air flows are forced ventilation air flows that pass, upon rotation of the said ventilated brake disc, through the space between two spaced apart friction rings of the said ventilated brake disc;
(c) the said air flow deflection means is mounted on at least one non-rotary vehicle component and provides at least one air flow baffle shroud with substantially U shaped radial cross section, the said baffle shroud surrounding at least a portion of the outer periphery of the said ventilated brake disc with a gap, deflecting the forced cooling air flows discharged from the outer periphery of the said rotating ventilated brake disc and directing the deflected air flows across the high temperature braking surfaces of the said ventilated brake disc.

26. The said air flow baffle shroud in claim 25 is further characterized by its inwardly sloped U shaped radial cross section and its ability to further accelerate the passing cooling air flow by virtue of gradually reduced gap between braking surfaces and the shroud.
